(19) United States
(12) Patent Application Publication
(10) Pub. No.: US 2010/0145972 A1
(43) Pub. Date: Jun. 10, 2010

(54) METHOD FOR VOCABULARY AMPLIFICATION

(76) Inventors: Oscar Kipersztok, Redmond, WA (US); David Vickrey, Menlo Park, CA (US); Philip Harrison, Seattle, WA (US); Daphne Koller, Portola Valley, CA (US)

Correspondence Address: Hayes Soloway P.C., 3450 E. Sunrise Drive, Suite 140, Tucson, AZ, 85718, US

(21) Appl. No.: 12/332,228

(22) Filed: Dec. 10, 2008

(51) Int. Cl. G06F 17/30; G06F 17/27

(52) U.S. Cl. 707/759; 704/9; 707/E17.001

(57) ABSTRACT

A method for finding similar search terms (word matching) is provided. The method receives a query of at least a first word and automatically applies the first word to a vocabulary amplifier. The vocabulary amplifier retrieves an associated word for the first word and accesses one or more database sources to retrieve an associated word. Each associated word is presented to an output interface. The amplifier then receives information from an input interface for the associated word and classifies the associated word based upon the received characterizing information.

### FIELD

The disclosure pertains to a system and method for query expansion.

### BACKGROUND

The search and retrieval of documents and text is a technology challenge that has been popularized since the creation of search engines such as Google and Yahoo. The ability to accurately retrieve documents for a specific query is a problem of increasing importance.

One major difficulty is that the most relevant queries may not contain the exact words used in the query. For example, if the query is “risks of smoking”, relevant documents may instead include the phrase “dangers of smoking.”Many existing search solutions or so-called query expansion methods rely on lists of key words that are matched to the words in the retrieved documents. Efforts to improve on word matching have focused on purely automatic methods for generating semantically similar terms. In many cases, the automatically generated set of related terms contains many words or phrases which are not relevant to the current query.

One particular method for addressing this problem is query expansion. The query expansion method takes the input query and generates a number of auxiliary queries with each word replaced by a word with similar semantic meaning. In our example of “risks of smoking”, “risks” is semantically similar to “dangers,” so a query expansion algorithm should generate the additionally query “dangers of smoking.”

Related work has focused on automatic methods for determining lists of related terms. Recent examples of such automatic methods in the context of query expansion for information retrieval include using a thesaurus for query expansion, and use of the context of a query term (i.e., the rest of the query) in order to clarify the meaning of that term and produce a better list of related terms.

These automatic methods have significant limitations resulting from a lack of information in the original query. These existing automatic methods also have difficulty determining the intended meaning of the words in the input query.

### SUMMARY

In the description that follows embodiments of the disclosure are described. In one embodiment, the present disclosure provides a method for providing query expansion, comprising: receiving a query automatically applying the words of the query to a vocabulary amplifier. Operation of the vocabulary amplifier further includes automatically accessing one or more database sources to retrieve an associated word. The associated word is then presented by the vocabulary amplifier to an output interface. Next, the vocabulary amplifier receives characterizing information from an input interface for the associated word. Finally, the vocabulary amplifier classifies the associated word based upon the characterizing information.

In another embodiment of the disclosure, a method for providing query expansion comprises: receiving a query automatically applying the phrases of the query to a vocabulary amplifier; and operating said vocabulary amplifier. Operation of the vocabulary amplifier further includes automatically accessing one or more database sources to retrieve an associated word or phrase. The associated word or phrase is then presented by the vocabulary amplifier to an output interface. Next, the vocabulary amplifier receives characterizing information from an input interface for each associated word or phrase. Finally, the vocabulary amplifier classifies each associated word or phrase based upon the received characterizing information.

In one embodiment of several possible embodiments of the disclosure provides a method for providing query expansion, wherein a processor is coupled to an input/output apparatus comprising an input interface and an output interface. A memory is coupled to the processor containing a learning machine program, a trained classifier program, and a memory portion for storing ranked list candidates. The processor has access to one or more database sources. When the processor is provided with a query comprising at least a first phrase, the processor uses the learning machine program and the trained classifier program to access the database sources to retrieve an associated word or phrase. Each associated word or phrase is then presented to the output interface and the processor receives characterizing information from the input interface for the associated word or phrase. Finally, the processor automatically classifies the associated word or phrase based upon the received characterizing information.

### BRIEF DESCRIPTION OF THE DRAWING

The features, functions, and advantages that have been discussed can be achieved independently in various embodiments of the present disclosure or may be combined in yet other embodiments further details of which can be seen with reference to the following description and drawings. The disclosure will be more fully understood from a reading of the following description of embodiments of the disclosure in conjunction with the drawing figures in which like designators refer to like elements, and in which:

FIG. 1 illustrates one embodiment of several possible embodiments of the disclosure.

FIG. 2 illustrates an embodiment of the disclosure in greater detail;

FIG. 3 illustrates the functional architecture of the embodiment of FIG. 2; and

FIG. 4 illustrates the functional operation of a portion of the functional architecture of FIG. 3.

### DETAILED DESCRIPTION

Some, but not all, embodiments of the disclosure are shown in the drawing figures. The disclosure may be embodied in many different forms and should not be construed as being limited to the described embodiments.

One embodiment of our disclosure is aimed at improving the accuracy of the query expansion by using a semi-automated approach that uses machine learning algorithms and user feedback. The embodiment of the disclosure provides a semi-automatic method for finding similar terms, in which input from the user is used to quickly generate a high-quality list of related terms thereby better capturing the meaning of the words in the original query.

One embodiment of the disclosure is an improved method for finding similar terms (word matching), to quickly generate a high-quality list of related terms, and better capture the meaning of the words in the original query. The embodiment provides the improved method by a combination of active learning techniques, efficient incorporation methods, machine learning techniques including incorporation of information from multiple sources, words clustered by contextual similarity and dynamic stopping criteria.

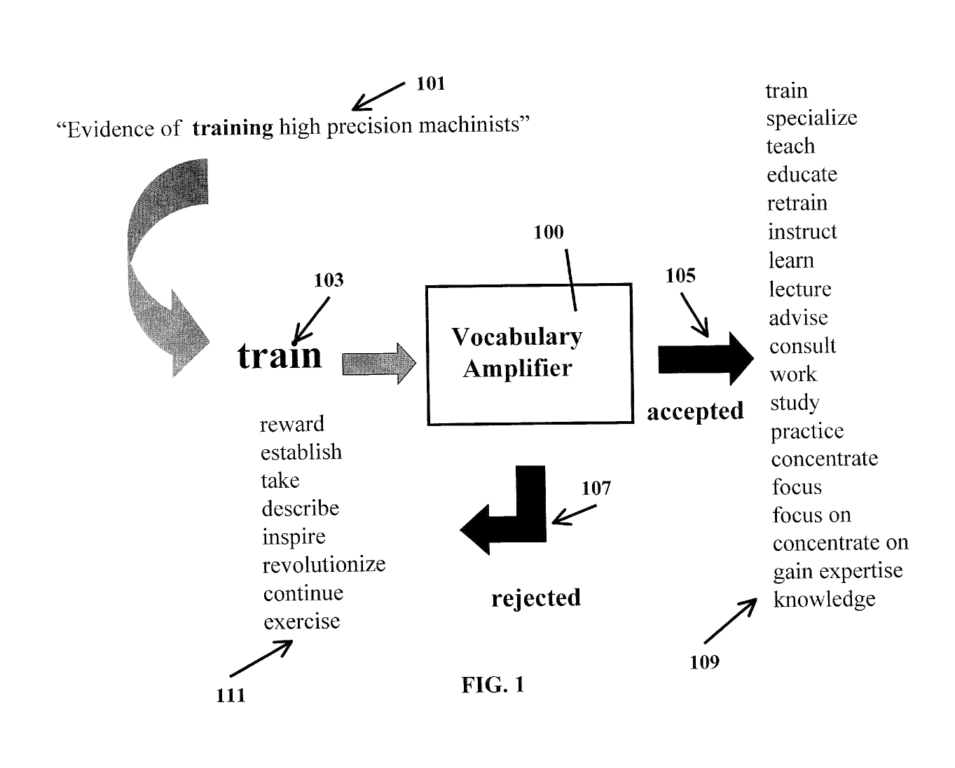

We refer to an embodiment of the disclosure as a “Vocabulary Amplifier.” The Vocabulary Amplifier 100 as shown in FIG. 1 enhances each word in a rule-base algorithm into a set of semantically similar words to improve recall of retrieved documents without diminishing precision. Vocabulary Amplifier 100 helps transform or map the mental model into a query.

By way of non-limiting example, in one instance a user inputs a word or phrase to vocabulary amplifier 100 which successively retrieves new words (or phrases) from various database sources that have semantically similar meaning to the input word (or phrase). As shown in FIG. 1, a user desires to search on phrase 101 “Evidence of training high precision machinists.” Each word 103 of phrase 101 is provided to vocabulary amplifier 100. Vocabulary amplifier 100 retrieves new words or phrases from the various database sources. Each retrieved word or phrase is presented to the user. After each word (or phrase) is presented the user either accepts or rejects it before a new word (or phrase) is presented. The result is a list of accepted words 105 and rejected words 107. In each iteration vocabulary amplifier 100 “learns” the intended meaning of the word and retrieves words with increasing semantic proximity to the original word. After a number of iterations vocabulary amplifier 100 suggests to the user a stopping point where sufficient words have been retrieved and it may not be worth continuing the process further.

Vocabulary amplifier 100 quickly and efficiently finds words or phrases which are semantically similar to a given input word or phrase. Since the input word may have multiple meanings, vocabulary amplifier 100 queries the user in order to determine the intended meaning. To this end, vocabulary amplifier 100 combines multiple sources of information about word similarity.

Vocabulary amplifier 100 applies several techniques or methods to the task of finding lists of semantically related words.

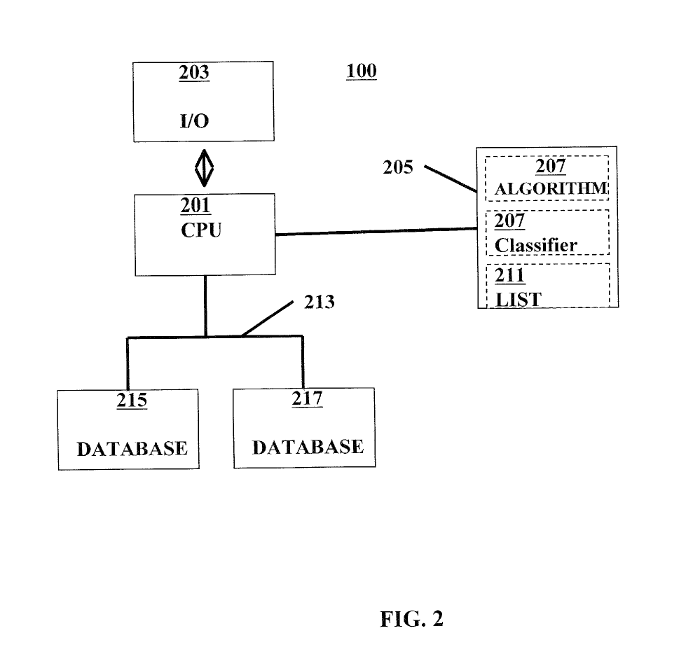

Turning now to FIG. 2, an embodiment of vocabulary amplifer 100 is shown. It will be appreciated by those skilled in the art that many embodiments exist that may embody the disclosure.

Vocabulary amplifier 100 includes a processor 201 coupled to input/output apparatus 203. A memory 205 includes a learning machine program 207, a trained classifier program 209 and a memory portion 211 for storing a ranked list of candidates. In addition, vocabulary amplifier 100 further has access 213 to various databases 215, 217. Databases 215, 217 may be co-located with vocabulary amplifier 100 or one or more databases 215, 217 may be remote from vocabulary amplifier 100. Access 213 may be of any one or more access arrangements such as a bus arrangement, wireless arrangement or the like. Vocabulary amplifier 100 may be incorporated into an existing system or product, or it may be stand alone. Since the primary operational aspects of vocabulary amplifier 100 reside in software stored in memory 205, it will be appreciated by those skilled in the art that vocabulary amplifier 100 may be integrated into any electronic device having a processor and memory that can store learning machine program 207, trained classifier program 209, and memory portion 211. Input/output apparatus 203 may be any known apparatust that provides for interactive communication. One example is a keyboard and display. Another example is a touch screen. A further example is an audio output and a voice recognition apparatus.

Vocabulary amplifier 100 utilizes active learning to efficiently incorporate user input to create related word lists. This allows accurate capture of the intended meaning of the query, which is difficult using automatic methods.

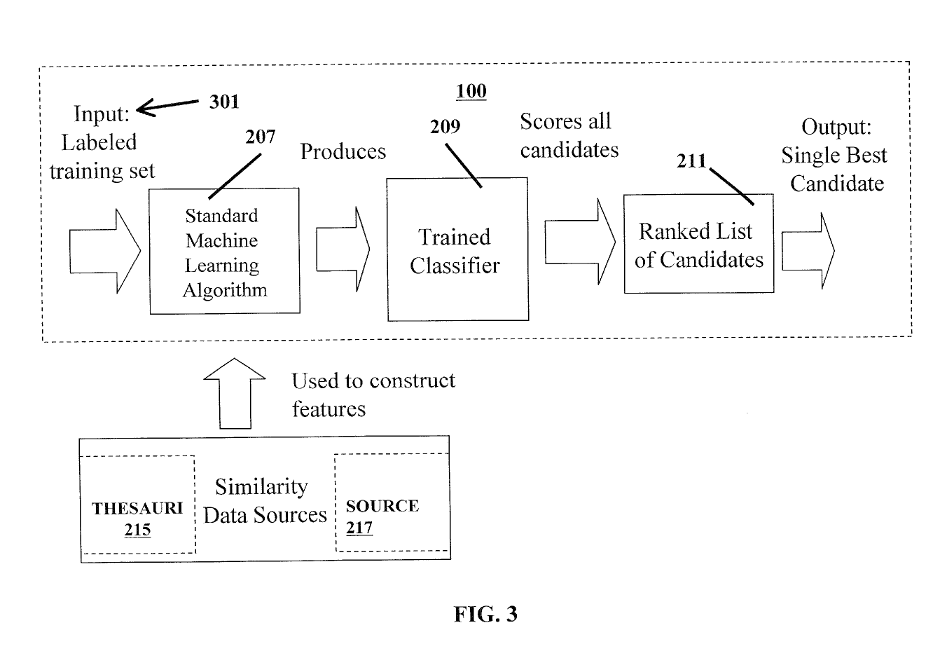

Turning now to FIG. 3, machine learning techniques, typically provided by one or more machine learning algorithms 207 allow incorporation of information from multiple sources or databases including manually created from resources such as thesauri 215, and other sources 217, including for example automatically generated resources such as words clustered by contextual similarity. This allows for better coverage of the space of possible meanings by incorporating many possible types of similarity.

A dynamic stopping criterion automatically decides when to stop querying the user for additional information. This increases efficiency by reducing the amount of input required of the user.

Turning back to FIG. 1, a user inputs a word or phrase 107 and vocabulary amplifier 100 successively retrieves new words (or phrases) from various database sources that have semantically similar meaning to the input word 103 (or phrase). After each new word (or phrase) is presented the user either accepts 105 or rejects 107 the new word before the next new word (or phrase) is presented. Vocabulary amplifier 100 generates a list of accepted words 109 and rejected words 11. After a number of iterations, vocabulary amplifier 100 suggests to the user a stopping point where a sufficient number of words have been retrieved and it may not be worth continuing the process further.

Vocabulary amplifier 100 finds similar search terms (word matching), quickly generates a high-quality list of related terms, and better captures the meaning of the words in the original query.

Vocabulary amplifier 100 utilizes an active learning technique via machine learning algorithms 207. Machine learning algorithms 205 require a training set 301 of labeled examples as input as shown in FIG. 3.

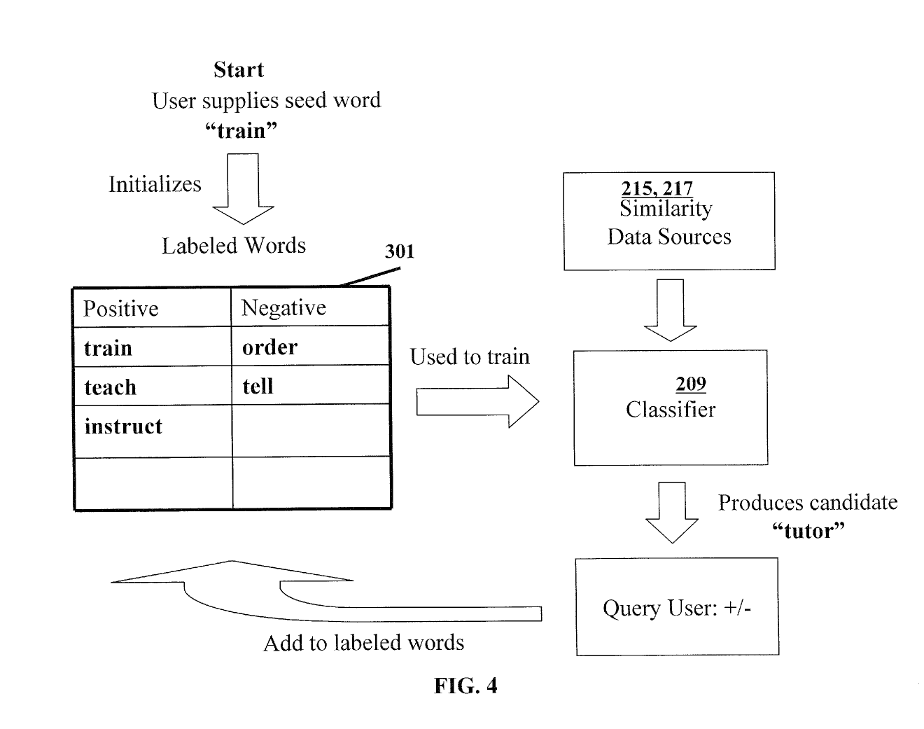

In one of several possible embodiments of the disclosure, a training set 301 is iteratively built by repeatedly prompting a user to provide a label (positive or negative, i.e accept or reject) for a new word or phrase as shown in FIG. 4. As each corresponding word is obtained from databases 215, 217 the user is prompted with the word assigned the highest score by a machine learning algorithm trained on a current set of labeled examples. This process allows vocabulary amplifier 100 to quickly learn what words the user is interested in without the user needing to label a large number of negative examples.

New words or phrases are obtained from various database sources 215, 217 that have somatically similar meaning to the input word (or phrase). For every word and phrase, a list of related words, ordered and scored according to degree of similarity is obtained from database sources 215, 217. For example, for the word “dog”, we would expect “hound” to be very similar, “cat” to be somewhat similar, and “truck” to not be similar.

Database 215 comprises information from a thesaurus. Many thesauri provide a full-scale hierarchy over words, telling us not only that “hound” and “dog” are synonyms, but also that “dog” belongs to the larger category of “animals”. This ontology is processed using standard scoring methods in order to produce scored lists of similar words.

A second scoring method utilizes information about co-occurrence of words in natural language, often referred to as distributional clustering. As a simple example, if both “cat” and “dog” tend to occur as subjects of the verb “eat”, then we have a clue that they may be similar. Given a large corpus of text, distributional clustering also produces scored lists of related words.

As described above, active learning is utilized to efficiently incorporate user input into the process of creating related word lists. User input to every iteration improves the chance that learning algorithm 207 will find another semantically similar word.

Machine learning classifier 209 takes as input a labeled training set 401 of positive and negative examples. When classifier 209 is given a new example, it predicts whether that example is positive or negative. Classifier 209 outputs a confidence indication, indicating how sure the classifier 209 is about its prediction. As will be appreciated by those skilled in the art, classifier 209 may be any one of a number of standard classifiers, such as Support Vector Machines and Boosted Decision Trees.

As machine learning algorithm 207 retrieves additional similar words, eventually, the time between positive words increases on the average. Eventually, the list of positive similar words is sufficient so the user doesn't need to wait for an additional word. Stopping conditions recommend potential stopping points for the process. These conditions may include, for example, time limits, stall time limits, or any other conditions or combination of conditions commonly know in the art for determining a stopping point for an algorithm.

Vocabulary amplifier 100 can be used in queries to improve the performance of an information retrieval system.

A mental model is a list of concepts that identifies the most important ideas of a domain of interest. It is the context for the use of the words generated by vocabulary amplifier 100. For example, in the domain of “Aviation Safety”, one of the concepts would be the “occurrence of accidents”. Vocabulary amplifier 100 enhances each word in the rule-base algorithm into a set of semantically similar words to improve recall of retrieved documents without diminishing precision. Vocabulary amplifier 100 helps transform or map a mental model into a set of queries.

Since each input word may have multiple meanings, the user query aspect of vocabulary amplifier is a particularly efficient way to determine the intended meaning.

What is claimed is:

1. A method for providing query expansion, comprising:
receiving a query comprising at least a first word;
automatically applying said first word to a vocabulary amplifier;
operating said vocabulary amplifier to execute the following steps:
automatically accessing one or more database sources to retrieve an associated word;
automatically presenting each said associated word to an output interface;
receiving characterizing information from an input interface for said associated word; and
automatically classifying said associated word based upon said received characterizing information.

2. The method in accordance with claim 1, comprising:
repeating the operation of said vocabulary amplifier with said first word for retrieving additional associated words.

3. The method in accordance with claim 2, comprising:
providing said vocabulary amplifier with an algorithm to determine when to terminate retrieving any further additional associated words.

4. The method in accordance with claim 3, comprising;
utilizing said algorthm to provide a dynamic stopping criteria for retrieving said additional associated words.

5. The method in accordance with claim 1, comprising:
providing a thesaruri as one of said database sources.

6. The method in accordance with claim 2, comprising:
providing said vocabulary amplifier with a learning algorithm such that said vocabulary amplifier utilizes each said associated word to learn the intended meaning of said first word.

7. The method in accordance with claim 6, wherein:
utlizing each said intended meaning to retrieve associated words having increased semantic proximity to said first word.

8. A method for providing query expansion, comprising:
receiving a query comprising at least a first phrase;
automatically applying said first phrase to a vocabulary amplifier; and
operating said vocabulary amplifier to execute the following steps:
automatically accessing one or more database sources to retrieve an associated word or phrase;
automatically presenting each said associated word or phrase to an output interface;
receiving characterizing information from an input interface for said associated word or phrase; and
automatically classifying said associated word or phrase based upon said received characterizing information.

9. The method in accordance with claim 8, comprising:
providing said vocabulary amplifier with a learning algorithm such that said vocabulary amplifier utilizes each said associated word or phrase to learn the intended meaning of said first phrase.

10. The method in accordance with claim 9, wherein:
utlizing each said intended meaning to retrieve associated words or phrases having increased semantic proximity to said first word or phrase.

11. The method in accordance with claim 10, comprising:
providing said vocabulary amplifier with a second algorithm to determine when to terminate retrieving any further additional associated words or phrases.

12. The method in accordance with claim 11, comprising;
utilizing said second algorthm to provide a dynamic stopping criteria for retrieving said additional associated words.

13. A method for providing query expansion, comprising:
providing a processor coupled to input/output apparatus comprising an input interface and an output interface;
providing a memory coupled to said processor and containing a learning machine program, a trained classifier program, and a memory portion for storing ranked list candidates;
providing said processor with access to one or more database sources;
providing said processor with a query comprising at least a first phrase;
automatically operating said processor with said learning machine program and said trained classifier program to access said one or more database sources to retrieve an associated word or phrase;
automatically operating said processor to present each said associated word or phrase to said output interface;
receiving characterizing information from said input interface by said processor for said associated word or phrase; and
operating said processor automatically to classify said associated word or phrase based upon said received characterizing information.

14. The method in accordance with claim 13, comprising:
providing said learning machine program with a learning algorithm to utilize each said associated word or phrase and its characterizing information to learn the intended meaning of said first phrase.

15. The method in accordance with claim 14, wherein:
said processor utlizes each said intended meaning to retrieve from said one or more database sources associated words or phrases having increased semantic proximity to said first word phrase.

16. The method in accordance with claim 15, comprising:
operating said processor with a second algorithm to determine when to terminate retrieving any further additional associated words or phrases.

17. The method in accordance with claim 16, comprising:
said processor utilizing each said associated word or phrase having first characterizing information in conjunction with said second algorithm.

18. The method in accordance with claim 17, comprising:
utilizing each said word or phrase having said first characterizing information to generate one or more additional queries.

19. The method in accordance with claim 18, comprising:
utilizing said query and said one or more additional queries to identify documents for retrieval.
